(19) United States
(12) Patent Application Publication
(10) Pub. No.: US 2013/0208263 A1
(43) Pub. Date: Aug. 15, 2013

(54) DEVICE FOR MEASURING, IN A PREDEFINED PLANE, THE POSITIONING OF A MATERIEL DEPOSITED AT THE BOTTOM OF THE WATER AND ASSOCIATED METHOD

(71) Applicants: Thierry Vaillant, Plougastel-Daoulas (FR); Hubert Leon, Guilers (FR)

(72) Inventors: Thierry Vaillant, Plougastel-Daoulas (FR); Hubert Leon, Guilers (FR)

(73) Assignee: ACTRIS, Brest Cedex 9 (FR)

(21) Appl. No.: 13/824,629

(22) PCT Filed: Aug. 3, 2010
(86) PCT No.: PCT/FR2012/000329

§ 371 Date: Apr. 18, 2013

(30) Foreign Application Priority Data
Aug. 4, 2011 (FR) 1102453

(51) Int. Cl. G01N 21/00

(52) U.S. Cl. CPC G01N 21/00
USPC 356/72

(57) ABSTRACT

A device for measuring magnetic magnitudes and more particularly, a device for measuring, in a predefined plan, the positioning of a material deposited at the bottom of the water, includes: a submersible laser transmitter; and a buoy having a first lower part designed to be at least partially submerged and an upper part designed to be at least partially emerged when the buoy floats on the water, the first part including a lower face arranged facing the bottom of the water when the buoy floats, the lower face being at least partially covered by an array of photodetector sensors able to detect the laser radiation emitted by the transmitter.

### CROSS-REFERENCE TO RELATED APPLICATIONS

This application is a U.S. National Phase application under 35 U.S.C. §371 of International Application No. PCT/FR2012/000329, filed Aug. 3, 2012, which claims priority of French patent application no. 1102453 filed on Aug. 4, 2011.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention relates to the field of devices for measuring magnetic magnitudes and more particularly to a device for measuring, in a predefined plan, the positioning of a materiel deposited at the bottom of the water.

2. Description of the Related Art

The discretion of surface and submarine vessels is a strong operational constraint against an enemy interception threat and against the threat of mines. The measurement of the committed indiscretions is generalized in all the navies and standardized within NATO by the STANAGS.

Ships and underwater vehicles, all designated in the following by the generic term ship, are regularly controlled on measurement polygons in order to measure their levels of acoustic, magnetic and electromagnetic indiscretion, which make them potentially detectable by the enemy forces and mines.

These polygons are commonly composed of an assembly of acoustic, magnetic and electromagnetic sensors, respectively, placed at the bottom of or suspended in the water column, connected to a system for recording and analyzing the signals by means of an assembly of cables and transmission systems.

According to the prior art, during a control operation, the ship to be studied moves in the vicinity of the sensors of the polygon. While moving, the relative position of the ship with respect to those of the sensors of the polygon is measured and recorded at the same time as the signals from the sensors of the polygon. The positions and the signals are analyzed by means of computers and processing software that characterize the noises radiated by the ship and measure its indiscretion level. These analyses are the subject of reports which are used by the several concerned actors.

However, such installations exhibit many drawbacks. Thus, the measurement polygons are most of the time fixed and constituted of sensors placed on pedestals at the bottom of the water or attached by cables to the seabed. The measurements are therefore carried out in an often unfavorable environment, especially due to the shallow depth, the vicinity of acoustic, electromagnetic and magnetic noise sources or the parasitic passages of other ships.

The immobility of the measurement polygons creates a functional and geographical dependence between the ship and the control polygon. This dependence may extend in time depending on the weather and technical vagaries (hardware failures), which result in a reduction of the operational availability of the ship during the control.

In addition, the polygons constitute an infrastructure that is heavy, expensive and difficult to implement and to maintain which requires the presence of divers, numerous sensors, numerous submarine cables, ground facilities, navigation bans in the area, a temporary fitting-out by staff to be moved on site. They also require a large surface of facilities, military sites protected in front of the sea with underwater installations and therefore a reserved littoral zone.

In addition, since each polygon is installed on a specific geographic site, the measurement results for a same ship may vary depending on the selected polygon, especially due to the procedures and local environmental conditions such as the thickness of the sheet of water, the shape and the nature of the seabed, the levels of the ambient noises, the disparities of the materials and the procedures used.

Furthermore, the polygons can be transported and deployed in an operational theater. Following an average, a damage, or after a long journey to reach a battle theater, a ship cannot know its new indiscretion level, for lack of being able to pass again on its measurement polygon: it must make assumptions on the threat it incurs.

In addition, some polygons cannot physically make measurements in the far field, due to the local environment (relief and proximity of the seabed, insufficient spacing of the sensors, reverberation). The far-field indiscretion in this case must be calculated from uncertain measurements made in the near field and from models introducing additional, poorly controlled uncertainties.

However, patent application FR2679514 is known which describes a portable station for measuring and adjusting the magnetic signature of a naval vessel comprising several magnetic sensors connected to each another in order to form a deformable string designed to be deposited at the bottom of the sea and to which are associated means for transmitting data that they provide, comprising an antenna arranged on a ballasted buoy outside of the water. The positioning of the magnetic sensors with respect to the ship is determined using pressure sensors associated with the magnetic sensors, the calculation of the second derivative of the magnetic field and by a tracking method using optical, acoustic or magnetic aiming means.

This portable station also comprises a certain number of drawbacks. It requires on the one hand the presence of a shallow seabed, therefore the presence of the littoral and therefore an often unfavorable environment, and on the other hand the presence of divers to deposit the string of magnetic sensors. It also requires the determination of the relative positioning of each of the magnetic sensors which may result in the evaluation of an erroneous magnetic signature if the positioning is not accurately determined. Yet, if in surface an absolute positioning is in centimeter, it is of the order of a meter as soon as the depth exceeds 10 meters and, for evaluating the magnetic signature of a naval vessel, such an error on the positioning of the sensors results in obtaining an erroneous measured magnetic signature.

Furthermore, the abstract of patent JP63284418 is also known which describes a device for analyzing marine data and, more particularly, a device for servoing the position of an underwater buoy with respect to that of a submerged laser transmitter.

This device comprises a submersible laser transmitter and an underwater buoy electrically powered and controlled, via a cable, by a ground station. The transmitter is positioned at the bottom of the water and able to emit a vertical radiation while the buoy comprises a first lower portion designed to be at least partially submerged and having a lower face arranged facing the bottom of the water when the buoy floats, said lower face being at least partially covered by an array of photoreceptor sensors able to detect the laser radiation emitted by said transmitter. The buoy further comprises propulsion means and means for controlling the position of the buoy adapted to maintain said photodetector array to the vertical of said laser radiation from the measurement of the intensity of the radiation received by the photodetector array and by acting on the propulsion means.

Such a device does not allow to determine the geographical position neither of the submerged laser transmitter nor of the underwater buoy.

The aim of the invention is to provide a device and an associated method for measuring the positioning of a materiel deposited at the bottom of the water, preferably at a depth of less than 30 m, for positioning it with a measurement uncertainty of the order of that obtained in surface.

### BRIEF SUMMARY OF THE INVENTION

The provided solution is a device for measuring the positioning of a materiel deposited at the bottom of the water, characterized by the fact that it comprises a submersible laser transmitter and a floating device, such as for example a buoy or a craft, with a first lower part designed to be at least partially submerged and comprising a lower face arranged facing the bottom of the water when the device floats on the water, said lower face being at least partially covered by an array of photoreceptor sensors able to detect the laser radiation emitted by said transmitter, said device further comprising means for satellite positioning, in latitude and longitude.

According to a particular feature, a floating device according to the invention comprises means for calculating the position of the laser transmitter from the signals from the photoreceptors and the means for satellite positioning.

By “positioning the materiel” it is to be understood a positioning in latitude and longitude with respect to the equator and the Greenwich meridian or a relative positioning with respect to a ground or sea reference station, such as a craft or a ship.

According to a particular feature, the floating device comprises means for processing the signals emitted by the photoreceptor array, means for processing the signals emitted by the means for satellite positioning, said processing means each comprising a clock, said clocks being synchronized with each other.

According to another particular feature for improving the positioning accuracy when the surface of the water is disturbed, which is generally the case at sea with the waves, the floating device comprises on the one hand means for measuring its inclination and orientation constituted for example by a compass and a 2 axis inclinometer and, on the other hand, means for calculating the position of the laser transmitter from the signals from the photoreceptors, those from the means for satellite positioning and those from the means for measuring the inclination and orientation of the floating device.

According to a feature, the floating device comprises means for processing the signals emitted by the photoreceptor array, means for processing the signals emitted by the means for satellite positioning and means for processing the signals emitted by the means for measuring the inclination and orientation of the floating device, said processing means each comprising a clock, said clocks being synchronized with each other.

According to another feature for allowing a person on shore or on board of a craft to know when the device has detected the laser radiation, the device comprises means for visualizing the detection by said photoreceptor array of the radiation emitted by the laser transmitter, for example constituted by a bulb whose lighting is controlled by said processing means.

According to another feature for improving the positioning accuracy, the submersible laser transmitter is integral with a support able to maintain it in a fixed position, said support being for example able to comprise, a pendulum and able to maintain it so that the laser emission is emitted along a vertical axis.

According to an additional feature, a depth sensor is associated with the transmitter or its support.

The invention also relates to a method for measuring, in a predefined plane, the positioning of a materiel deposited at the bottom of the water implementable by a device comprising a submersible laser transmitter and a floating device, such as a buoy or a craft, with a first lower part designed to be at least partially submerged and comprising a lower face arranged facing the bottom of the water when the device floats on the water, said lower face being at least partially covered by an array of photoreceptor sensors able to detect the laser radiation emitted by said transmitter, said floating device further comprising means for satellite positioning, in latitude and longitude, and means for calculating the position of the laser transmitter from the signals from the photoreceptors and the means for satellite positioning, method characterized by the fact that it comprises the following steps of:
submerging and positioning a support of a laser transmitter and/or the latter on said materiel so that it is able to vertically emit a laser radiation;
triggering the laser emission;
moving the device until the photodetector array detects said laser radiation;
calculating the position of the laser transmitter from the signals from the photoreceptors and the means for satellite positioning.
   This method is usable particularly in calm water such as on a lake in the absence of wind.

The invention also relates to a method for measuring, in a predefined plane, the positioning of a materiel deposited at the bottom of the water implementable by a device comprising a submersible laser transmitter and a floating device, such as a buoy or a craft, said floating device comprising:
a first lower part designed to be at least partially submerged and comprising a lower face arranged facing the bottom of the water when the device floats on the water, said lower face being at least partially covered by an array of photoreceptor sensors able to detect the laser radiation emitted by said transmitter;
means for satellite positioning, in latitude and longitude;
means for measuring its inclination and orientation, constituted for example by a compass and a 2 axis inclinometer and, on the other hand;
means for calculating the position of the laser transmitter from the signals from the photoreceptors, those from the means for satellite positioning and those from the means for measuring the inclination and orientation of the device;
   method characterized by the fact that it comprises the following steps of:
submerging and positioning a support of a laser transmitter and/or the latter on said materiel so that it is able to vertically emit a laser radiation;
triggering the laser emission;
moving the device until the photodetector array detects said laser radiation;
calculating the position of the laser transmitter from the signals from the photoreceptors, those from the means for satellite positioning and those from the means for measuring the inclination and orientation of the device.
   This process is usable both in calm and rough water as well as in the sea or in a lake with wind generating waves.

### BRIEF DESCRIPTION OF THE SEVERAL VIEWS OF THE DRAWING

Other advantages and features will become apparent in the description of a particular embodiment of the invention with reference to the appended figures, in which:

FIG. 1 shows a general scheme of a device according to a first embodiment of the invention;

FIG. 2 shows a scheme of a first assembly implemented in the framework of an embodiment of the invention;

FIG. 3a shows a second assembly implemented in the framework of said embodiment of the invention;

FIG. 3b shows a second assembly implemented in the framework of another embodiment of the invention;

FIG. 4 shows an exemplary method for implementing the invention for obtaining an absolute positioning of a submerged materiel.

### DETAILED DESCRIPTION OF THE INVENTION

FIG. 1 shows a general scheme of a device 1 according to an embodiment of the invention.

This device 1 comprises a first assembly 19 comprising a laser transmitter and a second assembly 20 comprising a buoy. These assemblies are independent, namely not connected to each other by material means.

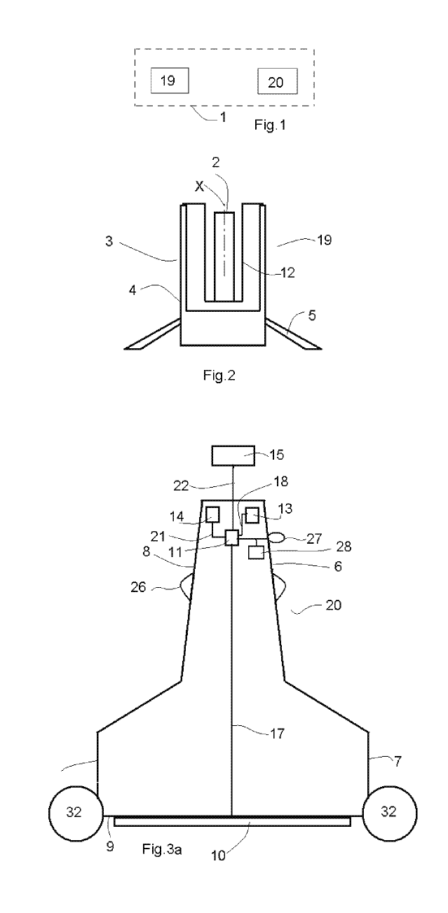

FIG. 2 shows a scheme of the first assembly 19 implemented in the framework of an embodiment of the invention.

This first assembly 19 comprises a submersible laser transmitter 2, mounted on a support 3. This support 3 comprises a tubular element 4 comprising adjustable stabilizing legs 5, and a pendulum 12 on which the laser transmitter 2 is fixed. Thus, the laser transmitter is able to emit a radiation along a vertical direction, even if the X axis of the tubular support is not perfectly vertically arranged.

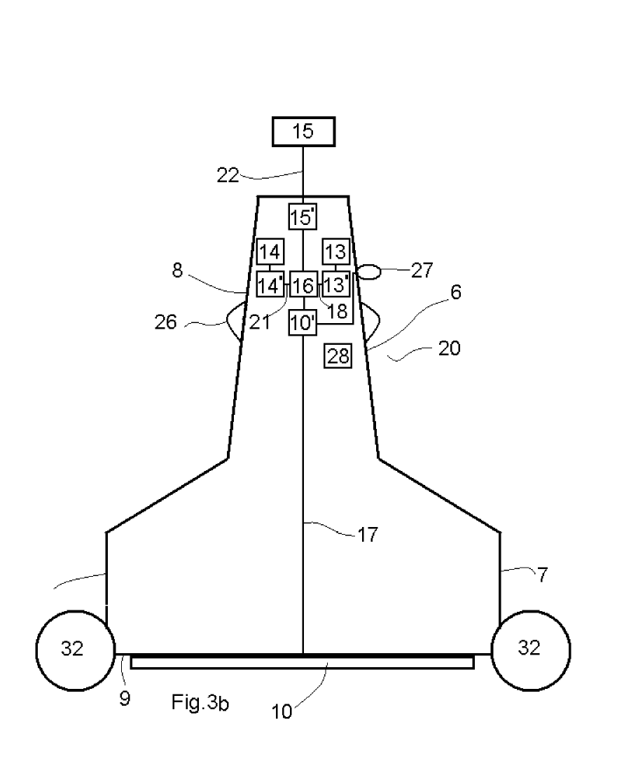

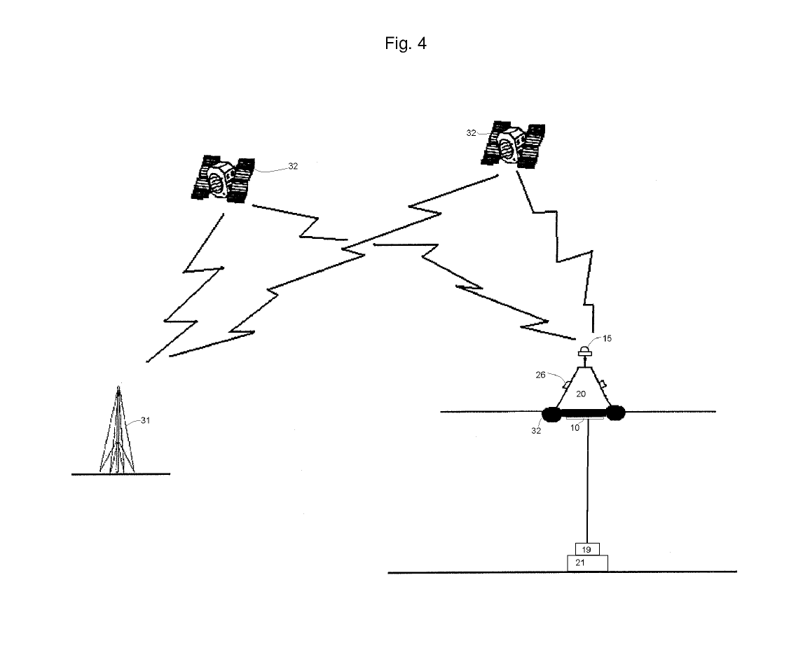

FIG. 3a shows a second assembly implemented in the framework of a first embodiment of the invention.

This second assembly 20 comprises a buoy 6 comprising a first lower part 7 designed to be at least partially submerged and an upper part 8 designed to be at least partially emerged when the buoy 6 floats on the water, said first part 7 comprising a lower face 9 arranged facing the bottom of the water when the buoy floats, said lower face being at least partially covered by an array 10 of photoreceptor sensors able to detect the laser radiation emitted by said submersible transmitter 2.

This array 10 of photoreceptor sensors is connected by a wire link 17 to means 11 for processing the signals emitted by each of these sensors.

This second assembly also comprises means 13, 14 for measuring the inclination and orientation of the buoy 6 constituted by a compass 13 and a 2 axis inclinometer 14 connected by wire connections 18 and 21, respectively, to said processing means 11.

This second assembly further comprises means 15 for differential GPS type satellite positioning, connected by wire connection to said processing means 11.

The processing means 11 comprise a clock and means for synchronizing this clock to that of means 15 for satellite positioning. They further comprise means for calculating the position of the laser transmitter from the signals from the photoreceptors, those from the means for measuring the inclination and orientation of the buoy and those from the means for satellite positioning.

The upper part 8 of the buoy 6 comprises two handles 26 to facilitate its launching and hoisting on board a ship. It further comprises a green colored bulb 27 connected on the one hand to a battery 28 for its power supply and on the other hand to said processing means 11, the latter being able to control the lighting of said bulb 27 when the array of photoreceptor sensors detects the presence of said laser radiation. The battery 28 also powers the processing means 11 as well as the array 10 of photoreceptors, the means 13, 14 for measuring the inclination and orientation of the buoy 6 as well as the means 15 for satellite positioning.

The buoy also comprises floats 32 further ensuring protection of the array of photodetector sensors.

FIG. 3b shows a second assembly implemented in the framework of a second alternative embodiment of the invention.

This second assembly 20 comprises a buoy 6 comprising a first lower part 7 designed to be at least partially submerged and an upper part 8 designed to be at least partially emerged when the buoy 6 floats on the water, said first part 7 comprising a lower face 9 arranged facing the bottom of the water when the buoy floats, said lower face being at least partially covered by an array 10 of photoreceptor sensors able to detect the laser radiation emitted by said submersible transmitter 2.

This array 10 of photoreceptor sensors is connected by a wire connection 17 to means 10′ for processing the signals emitted by each of these photoreceptor sensors.

This second assembly also comprises means 13, 14 for measuring the inclination and orientation of the buoy 6 as well as respective means 13′ and 14′ for processing the signals from these measuring means. The latter may be for example constituted by a compass 13 and a 2 axis inclinometer 14.

This second assembly further comprises means 15 for differential GPS type satellite positioning as well as means 15′ for processing the signals from said positioning means 15.

The means 10′, 13′, 14′ and 15′ for processing the signals from the photodetector array 10, the means 13, for measuring the inclination and orientation of the buoy 6 and the means 15 for satellite positioning, are connected by wire connections 17, 18, 21 and 22, respectively, to means 16 for calculating the position of the laser transmitter from the signals from the photoreceptors, those from the means for satellite positioning and those from the means for measuring the inclination and orientation of the device.

In addition, each of said processing means comprises a clock and said clocks are synchronized with each other.

The upper part 8 of the buoy 6 comprises two handles 26 to facilitate its launching and hoisting on board a ship. It further comprises a green colored bulb 27 connected on the one hand to a battery 28 for its power supply and on the other hand to said means 10′ for processing the signals from the photoreceptor sensors, the latter being able to control the lighting of said bulb 27 when the array of photoreceptor sensors detects the presence of said laser radiation. The battery 28 also powers the several processing means as well as the photoreceptor array 10, the means 13, 14 for measuring the inclination and orientation of the buoy 6 as well as the means 15 for satellite positioning.

The buoy also comprises floats 32 further ensuring protection of the array of photodetector sensors.

FIG. 4 shows an exemplary method for implementing the invention for obtaining an absolute positioning of a submerged materiel.

A materiel 21 is deposited at the bottom of the water. The first assembly 19 is positioned on the materiel so that the X axis of the support is directed substantially vertically upwards.

The line 24 represents the surface of the water while the line 25 represents the bottom of the water.

The second assembly 20 comprising the buoy 6 floats on the water, a first part located below the waterline being submerged and a second part being emerged.

The means for differential GPS type satellite positioning comprise, in a known manner, the means 15, satellites 30 of which only two are represented and a ground station 31 but is however not necessary in the case where the phase corrections of the satellites from a ground station are sent by GSM type telephone network.

The operation of this device is as follows:

The first assembly 19 is submerged and the support of the transmitter is positioned on said materiel, whose position in the reference plane, namely the water surface, is searched and, if possible at its center and so that the transmitter is able to vertically emit a laser radiation in the direction of the water surface. The emission of the laser radiation is then triggered.

The second assembly 20 is then launched into the water and moved until the photoreceptor sensors detect the laser radiation.

As soon as the laser radiation has been detected by one or more sensors, the processing means 11 calculate the position of said materiel depending on:
the position in the array of the one or more sensors having detected the radiation;
the inclination of the second assembly with respect to the reference plane determined by the inclinometer 14 and its orientation determined by the compass 13;
the GPS position of the second assembly with respect to that of the fixed station 31 (or that of any reference station whose corrections are sent via GSM type phone).
   The positioning units of the materiel may be for example in latitude and longitude.

In particular, the method for determining the position of the laser transmitter can be as follows:

As soon as one of the photoreceptors of the array is illuminated, said photoreceptor, located by its position on the photoreceptor array, is associated with a DGPS point synchronized on time T calculated by the processing means from the data taken into account, namely the position of the illuminated photoreceptor, the orientation and inclination of the buoy, the GPS position of the second assembly.

Subsequently, the movement of the buoy will cause illuminating of other photoreceptors to which other DGPS points synchronized on successive times t+n, t+n+1, etc., will be associated. These receptors will therefore provide GPS position information that all correspond to the GPS position of the LASER Spot of the object deposited at the bottom of the water.

Having a population of samples (points) corresponding to the GPS measurement at different times, positions subject to uncertainties related to the movement, system performance, insufficient (or even multiple) illumination depending on the size of the light spot that hits the buoy, the processing means implement the least squares method to determine the point TRUE, best estimate of the position calculated from this population.

In this exemplary embodiment, said method further calculates the measurement uncertainty. To do so, assuming that the point TRUE is the reference and using only the data cited above at the successive times t, t+n, t+n+1, etc., the processing means calculate the THEORETICAL illumination of the array at each time, and thus the position of the photoreceptor that should be illuminated at each of these times.

In the end, the processing means have calculated two results: the actual illumination (lighting of the photoreceptors during the measurement) and theoretical illumination which must be bound by the relation

actual illumination=theoretical illumination±displayed uncertainty of the complete device

The uncertainty of the complete device is the performance uncertainty of the device, uncertainty deliberately expanded which corresponds to the most unfavorable situation and helps ensure a general measurement result. When the distance between the buoy and the fixed station 31 is less than 10 km, the accuracy of the differential GPS positioning is of the order of 5 to 10 cm and, with a device according to the invention, the positioning of the laser transmitter is therefore of that order while the accuracy is metric for the positioning of the buoy with an autonomous GPS device.

Furthermore, when the laser radiation has been detected by one or more sensors, the processing means 11 control the lighting of the bulb 28.

In a particular embodiment, the laser transmitter is associated with a depth sensor and with means for underwater emitting this signal in the direction of the buoy 6 and/or a ship.

These emission means may be acoustic means. These means may further emit at a certain frequency a signal. Means for detecting said signal and determining its direction at least in heading are associated with the buoy and/or the ship. In the first case, the buoy may be equipped with propulsion means able to direct it along said heading while in the second case, the ship may be steered in that direction and the buoy deposited at the detection location of the emission of said signal. It should be noted that these acoustic detection means have an accuracy that is metric at best, while the invention, with the use of DGPS means, allows to obtain an decimetric accuracy on the position of the laser transmitter, therefore 10 times better.

A lower accuracy on the depth may be obtained from the intensity value of the laser radiation detected by the photodetector array and that emitted by the laser transmitter.

Numerous modifications may be made to the exemplary embodiment described above without departing from the scope of the invention. Thus, the means for measuring the inclination and orientation of the second assembly 20 may for example consist of gyroscopes. Moreover, the processing means may be swerved onto a ship. Furthermore, the shape of the support of the transmitter may be any shape, provided that the position of the transmitter is stable. In addition, emission means and an antenna may be for example associated with the processing means for allowing the transmission of the calculated position of said materiel to fixed or mobile reception means, which may for example be on board of a craft. Furthermore, the buoy may be replaced for example by a propelled or unpropelled craft.

### SEQUENCE LISTING

Not Applicable

1- A device for measuring the positioning, in latitude and longitude, of a materiel deposited at the bottom of the water characterized by the fact that it comprises:
an submersible laser transmitter;
a floating device, such as a buoy or a craft, with a first lower part designed to be at least partially submerged and comprising a lower face arranged facing the bottom of the water when the device floats on the water, said lower face being at least partially covered by an array of photoreceptor sensors able to detect the laser radiation emitted by said transmitter, said device further comprising means for satellite positioning, in latitude and longitude.

2- A device according to claim 1, characterized by the fact that the floating device comprises means for calculating the position of the laser transmitter from the signals from the photoreceptors and the means for satellite positioning.

3- A device according to claim 1, characterized by the fact that the floating device comprises means for processing the signals emitted by the photoreceptor array, means for processing the signals emitted by the means for satellite positioning, said processing means each comprising a clock, said clocks being synchronized with each other.

4- A device according to claim 1, characterized by the fact that the floating device comprises on the one hand means for measuring its inclination and orientation constituted for example by a compass and a 2 axis inclinometer and, on the other hand, means for calculating the position of the laser transmitter from the signals from the photoreceptors, those from the means for satellite positioning and those from the means for measuring the inclination and orientation of the floating device.

5- A device according to claim 4, characterized by the fact that the floating device comprises means for processing the signals emitted by the photoreceptor array, means for processing the signals emitted by the means for satellite positioning and means for processing the signals emitted by the means for measuring the inclination and orientation of the floating device, said processing means each comprising a clock, said clocks being synchronized with each other.

6- A device according to claim 1, characterized by the fact that the buoy comprises means for visualizing the detection by said photoreceptor array of the radiation emitted by the laser transmitter, for example constituted by a bulb whose lighting is controlled by said processing means.

7- A device according to claim 1, characterized by the fact that the submersible laser transmitter is integral with a support able to maintain it in a fixed position, said support being able for example to comprise a pendulum and able to maintain it so that the laser emission is emitted along a vertical axis.

8- A device according to claim 1, characterized by the fact that a depth sensor is associated with the transmitter or its support.

9- A method for measuring, in a predefined plane, the positioning of a materiel deposited at the bottom of the water implementable by a device comprising a submersible laser transmitter and a floating device, such as a buoy or a craft, with a first lower part designed to be at least partially submerged and comprising a lower face arranged facing the bottom of the water when the device floats on the water, said lower face being at least partially covered by an array of photoreceptor sensors able to detect the laser radiation emitted by said transmitter, said floating device further comprising means for satellite positioning, in latitude and longitude, and means for calculating the position of the laser transmitter from the signals from the photoreceptors and the means for satellite positioning, method characterized by the fact that it comprises the following steps of:
submerging and positioning a support of a laser transmitter and/or the latter on said materiel so that it is able to vertically emit a laser radiation;
triggering the laser emission;
moving the device until the photodetector array detects said laser radiation;
calculating the position of the laser transmitter from the signals from the photoreceptors and the means for satellite positioning.

10- A method for measuring, in a predefined plane, the positioning of a materiel deposited at the bottom of the water implementable by a device comprising a submersible laser transmitter and a floating device, such as a buoy or a craft, said floating device comprising:
a first lower part designed to be at least partially submerged and comprising a lower face arranged facing the bottom of the water when the device floats on the water, said lower face being at least partially covered by an array of photoreceptor sensors able to detect the laser radiation emitted by said transmitter;
means for satellite positioning, in latitude and longitude;
means for measuring its inclination and orientation, constituted for example by a compass and a 2 axis inclinometer and, on the other hand;
means for calculating the position of the laser transmitter from the signals from the photoreceptors, those from the means for satellite positioning and those from the means for measuring the inclination and orientation of the device,
method characterized by the fact that it comprises the following steps of:
submerging and positioning a support of a laser transmitter and/or the latter on said materiel so that it is able to vertically emit a laser radiation;
triggering the laser emission;
moving the device until the photodetector array detects said laser radiation;
calculating the position of the laser transmitter from the signals from the photoreceptors, those from the means for satellite positioning and those from the means for measuring the inclination and orientation of the device.

11- A device according to claim 2, characterized by the fact that the floating device comprises means for processing the signals emitted by the photoreceptor array, means for processing the signals emitted by the means for satellite positioning, said processing means each comprising a clock, said clocks being synchronized with each other.

12- A device according to claim 2, characterized by the fact that the buoy comprises means for visualizing the detection by said photoreceptor array of the radiation emitted by the laser transmitter, for example constituted by a bulb whose lighting is controlled by said processing means.

13- A device according to claim 2, characterized by the fact that the submersible laser transmitter is integral with a support able to maintain it in a fixed position, said support being able for example to comprise a pendulum and able to maintain it so that the laser emission is emitted along a vertical axis.

14- A device according to claim 2, characterized by the fact that a depth sensor is associated with the transmitter or its support.

15- A device according to claim 3, characterized by the fact that the buoy comprises means for visualizing the detection by said photoreceptor array of the radiation emitted by the laser transmitter, for example constituted by a bulb whose lighting is controlled by said processing means.

16- A device according to claim 3, characterized by the fact that the submersible laser transmitter is integral with a support able to maintain it in a fixed position, said support being able for example to comprise a pendulum and able to maintain it so that the laser emission is emitted along a vertical axis.

17- A device according to claim 3, characterized by the fact that a depth sensor is associated with the transmitter or its support.
